(19) United States
(12) Patent Application Publication
(10) Pub. No.: US 2015/0211811 A1
(43) Pub. Date: Jul. 30, 2015

(54) Plate Heat Exchanger Compression Apparatus

(71) Applicant: Mark Bradford Herndon, Plant City, FL (US)

(72) Inventor: Mark Bradford Herndon, Plant City, FL (US)

(73) Assignee: Industrial Bolting Systems Inc., Dover, FL (US)

(21) Appl. No.: 14/164,126

(22) Filed: Jan. 24, 2014

(51) Int. Cl. F28F 9/00; B23P 15/26; F16B 39/282; F28D 9/00

(52) U.S. Cl. CPC F28F 9/005; F28D 9/0062; B23P 15/26; F16B 39/282

(57) ABSTRACT

A novel plate heat exchanger opening and closing fixture having at least two hydraulic linear actuators located between a set of plates each having an opening to receive a plate heat exchanger threaded rod, whereby, the hydraulic opening and closing tool is secured to the threaded rod by a novel slip-on lock nut having at least one handle so an operator can rotate the slip-on lock nut without the need of a wrench. When the plates are hydraulically compressed clearance between the frame plate and the adjacent threaded rods having a slip-on lock nut with at least one handle are created. This clearance allows the slip-on lock nut having at least one handle to be more easily removed from an adjacent threaded rod.

### BACKGROUND OF THE INVENTION

1. Field of the Invention

The present invention relates, generally, to a plate heat exchanger opening and closing fixture. More particularly, it relates to at least two hydraulic linear actuators connected to a set of plates located at the opposing ends of at least two hydraulic linear actuators, each plate has an opening to receive the threaded rod of a plate heat exchanger and each plate is secured to the threaded rod by a novel slip-on lock nut having at least one handle so an operator can rotate the slip-on lock nut without the need of a wrench.

2. Background Art

Plate heat exchangers may need to be opened and closed for inspection, for maintenance, or to remove or add plates. The plate heat exchanger has a plurality of plates that are secured with threaded nuts along a series of threaded rods. Using a wrench to loosen and tighten a threaded nut on a rod that is holding back several tons of force from multiple plates can be labor intensive and time consuming. This manual opening and closing of the plate heat exchanger requires more than one person and more than one wrench to loosen or tighten the threaded nuts proportionately, while avoiding the cocking or binding of the plates. The plate heat exchanger is opened and closed just a fraction each time the wrench twists the threaded nut.

Currently, the plate heat exchanger rods are cut shorter than their original length to save time during manual removal of the threaded nuts from the threaded rods. A shorter threaded rod requires a shorter distance for the threaded nuts to travel during the removal or installation. The problem with shortening a threaded rod is that there comes a point where the heat exchanger can no longer accommodate additional plates because the length of the threaded rod is too short. There is a need for a plate heat exchanger to be opened and closed more easily and within a shorter time period without having to shorten the threaded rods.

Plate heat exchangers having a plurality of plates create a high pressure force applied to the fastener, such as a threaded nut, that is located along the plate heat exchanger threaded rod. Although a plate heat exchanger has a relatively high pressure force due to compression, without a way to relieve the force applied by the plates against the threaded nuts, opening and closing the plate heat exchanger will require many hours of time and the manual strength of a maintenance personnel.

There are several challenges to overcome with opening and closing a plate heat exchanger. One challenge being the need for the heat exchanger plates to be compressed to allow clearance between the heat exchanger frame plate and the threaded nuts. This clearance alleviates pressure on the threaded nuts, allowing the threaded nuts to spin freely without the need for tools. The problem with allowing clearance between the heat exchanger frame plate and the threaded nuts is determining how to compress the heat exchanger plates. Thus, there is a need for an improved method of compressing the heat exchanger plates to allow the plate heat exchanger to be efficiently opened and closed.

Currently, prior art plate heat exchanger opening and closing fixtures utilize a hydraulic system. These hydraulic systems have four individual hollow linear actuators, each having a central opening configured to receive a threaded rod located at each of the four corners of the plate heat exchanger. Each of these prior art hollow linear actuators are limited to only travel the length of the rod approximately three inches. Thus, there is a need for an improved, hydraulic system that allows for an increased travel length along the threaded rod, to facilitate a quicker opening and closing process.

Prior art hydraulic systems have hollow hydraulic linear actuators that travel along a plate heat exchanger rod at a fixed length. It is more desirable for a hydraulic system to be adapted to receive interchangeable linear actuators having a plurality of differing traveling lengths.

Prior art hollow hydraulic linear actuators have a limited displacement requiring the use of high hydraulic pressures. Hydraulic pumps capable of achieving these high pressures are more costly and require hydraulic lines capable of the intense pressure. Some hollow hydraulic linear actuators use an approximately 10,000 psi hydraulic pump to operate. The high pressures involved in using this type of system can be dangerous to operate and can result in operator injury. More particularly, the high pressure hydraulic system may fail if the frame plates are not kept parallel to each other, if the closing bolts are not securely in place, or if the linear actuators are not positioned firmly against the frame plate. Thus, there is a need for a hydraulic system that can facilitate the safe opening and closing of plate heat exchangers that operates on a hydraulic pressure having a lower psi of approximately 3,000 psi.

Some prior art hydraulic opening and closing systems incorporate a threaded nut to secure the hydraulic opening and closing system to the threaded rod of the plate heat exchanger. However, the problem with the prior art hydraulic opening and closing systems is that during the opening and closing process of the plate heat exchanger, the threaded nut is required to travel the length of the threaded rod. It can be time consuming and labor intensive to manually twist the threaded nut with a wrench along the length of the threaded rod. Thus, there is a need for an improved locking mechanism that secures the hydraulic opening and closing system to the threaded rod while eliminating the need for a threaded nut having to travel the length of the threaded rod during the opening and closing process.

More particularly, it is currently the practice for the use of an additional tool such as a wrench to install or remove the threaded nut when the plate heat exchanger is opened or closed. Thus, there is a need for an improved locking mechanism that eliminates the need for additional tools when securing the hydraulic opening and closing system to the threaded rod and eliminates the need for the threaded nut to have to travel the length of the threaded rod of a plate heat exchanger.

However, in view of the prior art considered as a whole at the time the present invention was made; it was not obvious to those of ordinary skill in the pertinent art how the identified needs could be fulfilled.

### SUMMARY OF THE INVENTION

The long-standing but heretofore unfulfilled need for a plate heat exchanger opening and closing fixture having at least two hydraulic linear actuators located between a set of plates each having an opening to receive the plate heat exchanger threaded rod, whereby, the hydraulic opening and closing tool is secured to the threaded rod by a slip-on lock nut having at least one handle so an operator can rotate the slip-on lock nut without the need of a wrench, and which also includes improvements that overcome the limitations of prior art plate heat exchanger opening and closing fixtures is now met by a new, useful, and non-obvious invention.

The novel plate heat exchanger compression apparatus includes a primary contact structure and a secondary contact structure each having a primary surface located opposite a secondary surface. The primary contact structure and the secondary contact structure each have an opening that is configured to receive a threaded rod of the plate heat exchanger assembly through the openings. The openings can be lined with any bushing material that will slide over a threaded rod including, but not limited to, aluminum, brass, bronze, steel, or nylon. Although it is a preferred embodiment for the bushing material to be a softer material than the material of the contact structures, it is within the scope of this invention for the contact structures to not be lined with a bushing material. The primary surface of the primary contact structure is in contact with a surface of a plate and the primary surface of the secondary contact structure is in contact with a fastener. The primary hydraulic linear actuator and the secondary hydraulic linear actuator each have a primary end connected to a secondary surface of the primary contact structure. The primary hydraulic linear actuator and the secondary hydraulic linear actuator each have a secondary end connected to a secondary surface of the secondary contact structure.

The primary hydraulic linear actuator and the secondary hydraulic linear actuator are each connected to a hydraulic source capable of transferring a fluid to or from the primary hydraulic linear actuator and the secondary hydraulic linear actuator. The primary hydraulic linear actuator and the secondary hydraulic linear actuator are in hydraulic communication with each other. The fluid is equally supplied to the primary hydraulic linear actuator and the secondary hydraulic linear actuator.

This novel invention also includes an improved slip-on lock nut having a primary nut member rotatably connected to a secondary nut member. The primary nut member and the secondary nut member each have at least one recess adapted to receive a threaded rod. At least one protrusion located on at least one nut member radiates from at least one nut member. At least one protrusion is configured to be grasped by a user. More particularly, the slip-on lock nut can have a primary protrusion and a secondary protrusion configured to be grasped by a user. At least one protrusion has a length of at least 2 inches.

In a preferred embodiment, the improved slip-on lock nut has a primary protrusion and a secondary protrusion configured for a user to grasp the primary protrusion and the secondary protrusion while connecting the primary and secondary nut member recess to the threaded rod. When the primary protrusion and the secondary protrusion are aligned, the primary and secondary nut members are oriented in a closed configuration, forming a jam nut binding to the threaded rod. Once the slip-on lock nut having a primary protrusion and a secondary protrusion is installed onto the threaded rod, the plates of the plate heat exchanger are hydraulically compressed.

When the plates are hydraulically compressed clearance between the frame plate and the adjacent threaded rods having a slip-on lock nut with a primary and a secondary protrusion are created. This clearance allows the slip-on lock nut having a primary and a secondary protrusion to be more easily removed from an adjacent threaded rod with the elimination of the need for the fastener to have to travel the length of the threaded rod during removal. More particularly, additional tools such as a wrench would not be required to remove the novel slip-on lock nut having a primary and a secondary protrusion. Maintenance personnel grasp the primary and the secondary protrusion and separate the primary and the secondary protrusion from their alignment to orient the primary and secondary nut members in an open configuration, whereby, being released from the threaded rod. The use of a slip-on lock nut having a primary and a secondary protrusion configured for a user to grasp while securing the plate heat exchanger opening and closing fixture to the threaded rod and while securing the plate heat exchanger plates to adjacent threaded rods, produces a faster and less labor intensive securing method than using conventional threaded nuts.

### BRIEF DESCRIPTION OF THE DRAWINGS

For a fuller understanding of the nature and objects of the invention, reference should be made to the following detailed description, taken in connection with the accompanying drawings, in which:

FIG. 1 is a perspective side view of the novel plate heat exchanger compression apparatus having a handle located on both hydraulic linear actuators and at least one hydraulic linear actuator being connected to a barrier element, the barrier element is located between the primary plate opening and the secondary plate opening;

FIG. 2 is an exploded view of the novel plate heat exchanger compression apparatus receiving a threaded rod of a plate heat exchanger and being secured to the threaded rod with a threaded nut;

FIG. 3 is a side perspective view of the novel plate heat exchanger compression apparatus being secured to a threaded rod of the plate heat exchanger by a threaded nut. When the plates of the plate heat exchanger are hydraulically compressed, clearance is created between the plates and between at least one threaded nut located on a plurality of adjacent threaded rods;

FIG. 4 is a front perspective view of a plurality of novel plate heat exchanger compression apparatuses each secured to a threaded rod on each of the four corners of the plate heat exchanger by a slip-on lock nut having at least one handle;

FIG. 5 is a perspective view of the novel slip-on lock nut having a first protrusion and a second protrusion configured to orient the primary and secondary nut members in an open configuration;

FIG. 6 is a perspective view of the novel slip-on lock nut having a first protrusion and a second protrusion aligned to orient the primary and secondary nut members in a closed configuration; and,

FIG. 7 is a perspective view of the novel plate heat exchanger compression apparatus being secured to a threaded rod with a slip-on lock nut having a first protrusion and a second protrusion.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

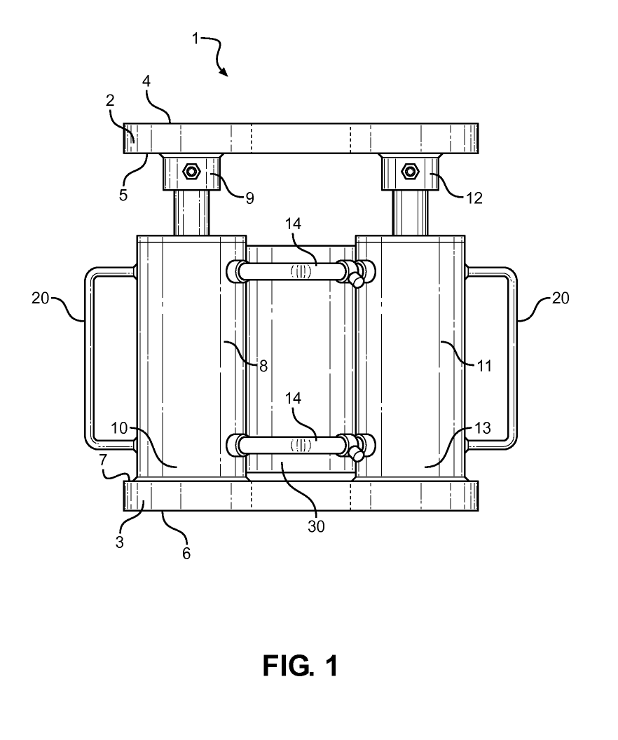

In a preferred embodiment, FIGS. 1, 2, 3, and 7 show plate heat exchanger compression apparatus 1 having primary contact structure 2 and secondary contact structure 3 being made of a ridged material including, but not limited to, steel. Primary contact structure 2 has primary surface 4 located opposite secondary surface 5. Secondary contact structure 3 has primary surface 6 located opposite secondary surface 7. Primary hydraulic linear actuator 8 has primary end 9 connected to secondary surface 5 of primary contact structure 2. Primary hydraulic linear actuator 8 has secondary end 10 connected to secondary surface 7 of secondary contact structure 3. Secondary hydraulic linear actuator 11 has primary end 12 connected to secondary surface 5 of primary contact structure 2. Secondary hydraulic linear actuator 11 has secondary end 13 connected to secondary surface 7 of secondary contact structure 3. A hydraulic linear actuator is any type of linear movement device including, but not limited to, a jack, a ram, or a hydraulic cylinder. Although the preferred embodiment is a hydraulic mechanism, it is within the scope of this invention to use any type of expanding and retracting device including, but not limited to, electric servo, pneumatic actuator, mechanical screw jack, rack and pinion, or any other device capable of linear movement.

FIG. 1 shows barrier element 30 connected to at least one hydraulic linear actuator. Barrier element 30 is located between opening 15 and opening 16 (not shown). Barrier element 30 acts as a barrier to protect hydraulic lines 14 from damage and is made of a ridged material, including, but not limited to, metal. FIG. 1 depicts primary hydraulic linear actuator 8 and secondary hydraulic linear actuator 11 each having at least one handle 20 adapted for a user to grasp. It is also envisioned that hydraulic linear actuator 8 and secondary hydraulic linear actuator 11 each having a lifting eye pad (not shown) located on a surface thereon.

Primary hydraulic linear actuator 8 and secondary linear actuator 11 are each connected to a hydraulic source (not shown) with hydraulic lines 14 (FIGS. 1, 2, 3, and 7) The hydraulic source is capable of transferring a fluid (not shown) to or from primary hydraulic linear actuator 8 and secondary hydraulic linear actuator 11. Primary hydraulic linear actuator 8 and secondary linear actuator 11 are in hydraulic communication with each other. A fluid (not shown) is equally supplied to primary hydraulic linear actuator 8 and secondary hydraulic linear actuator 11.

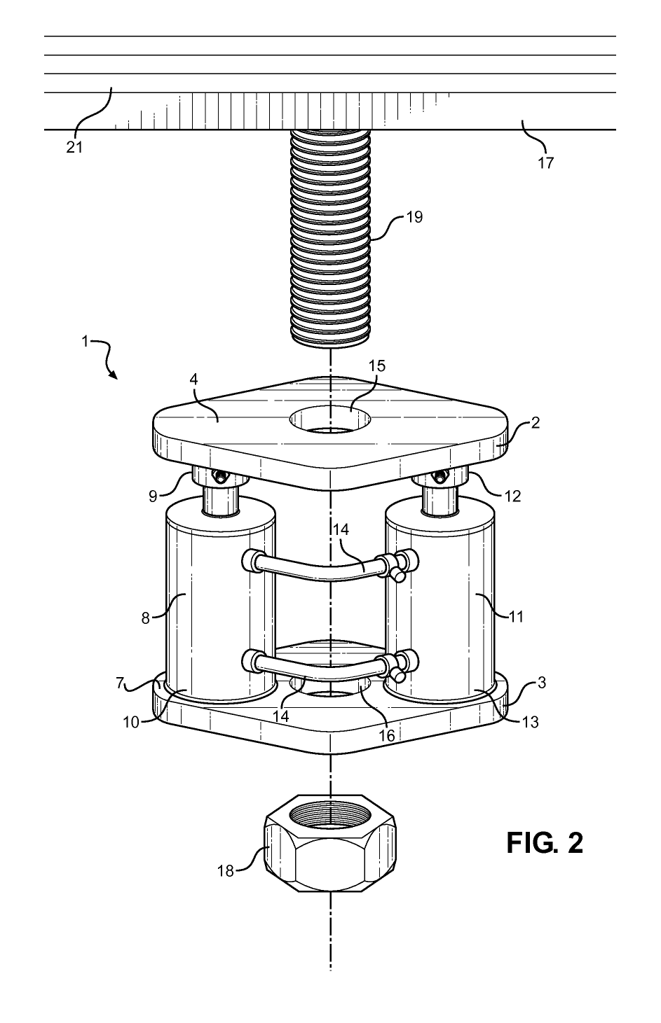

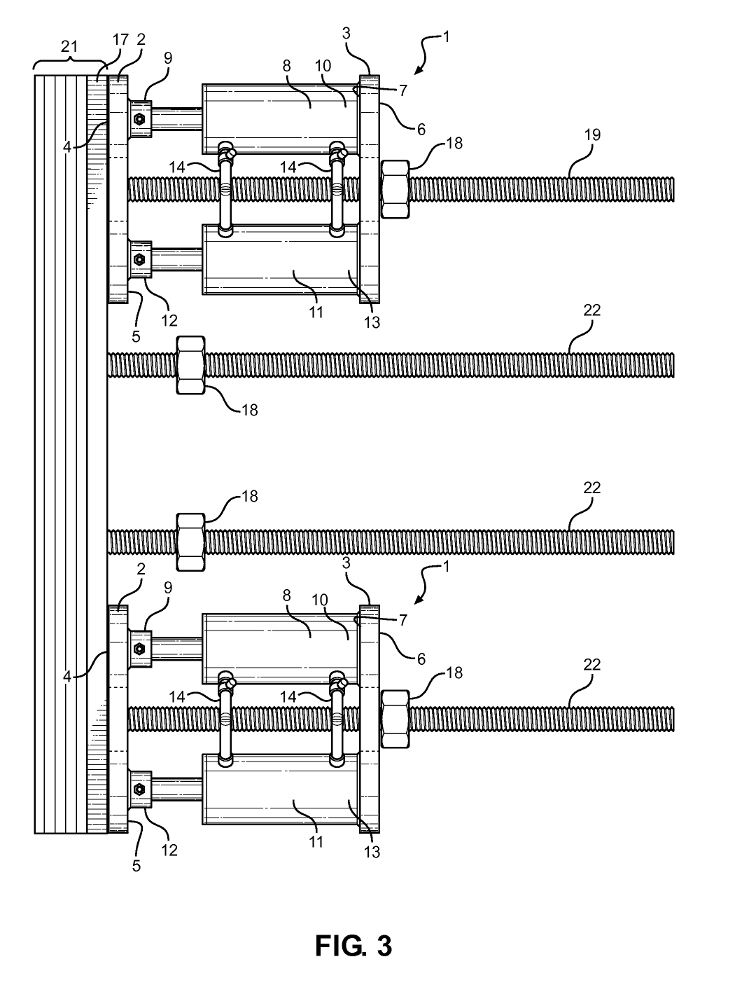

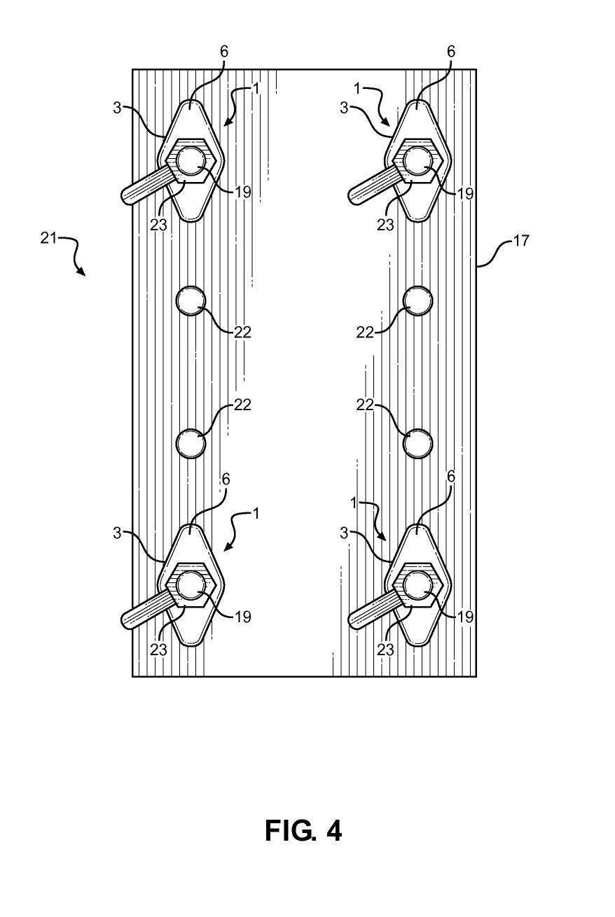

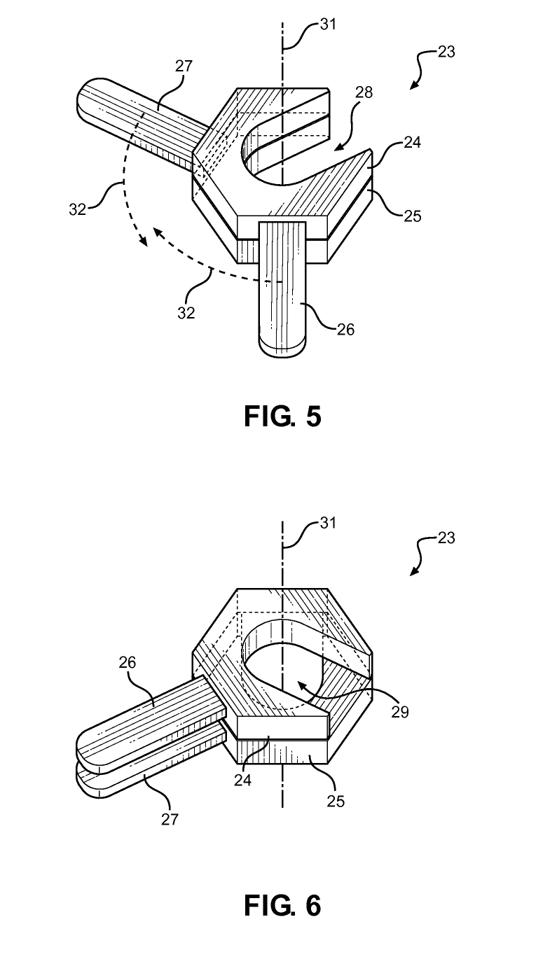

FIG. 2 shows primary contact structure 2 having opening 15 and secondary contact structure 3 having opening 16. Opening 15 and opening 16 are configured to receive threaded rod 19. FIG. 3 shows primary surface 4 of primary contact structure 2 in contact with a surface of plate heat exchanger 21 including, but not limited to, frame plate 17. Primary surface 6 of secondary contact structure 3 is in contact with fastener 18. Fastener 18 includes, but is not limited to, a threaded nut (FIGS. 2, and 3), a slip-on lock nut (not shown), a slip-on lock nut having at least one handle (FIGS. 4-7) or a slip-on lock nut having first handle and a second handle configured to be grasped by a user (FIGS. 5-7).

FIGS. 3 and 4 illustrate plate heat exchanger 21 having at least one plate heat exchanger compression apparatus 1 positioned along threaded rod 19 to bias against frame plate 17. Fastener 18 secures plate heat exchanger compression apparatus to rod 19 (FIG. 3). The plurality of plates of plate heat exchanger 21 is secured along adjacent rods 22 with fasteners 18 (FIG. 3).

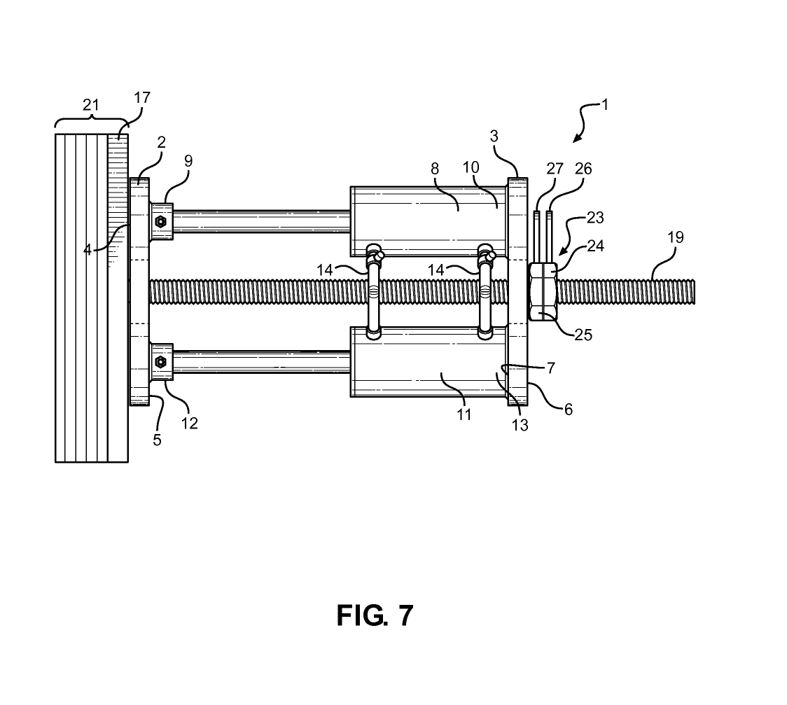

FIGS. 5-7 show slip-on lock nut having a primary nut member 24 rotatably connected to secondary nut member 25. Primary nut member 24 and secondary nut member 25 rotate along central axis 31. Primary nut member 24 has primary handle 26 configured to be grasped by a user (not shown). Secondary nut member 25 has secondary handle 27 configured to be grasped by a user. Primary nut member 24 and secondary nut member 25 have at least one recess 28 (FIG. 5) when oriented in an open configuration, adapted to receive threaded rod 19 (FIG. 7). The primary nut member 24 and secondary nut member 25 can be oriented 32 in a closed position. FIG. 6 best depicts primary handle 26 and secondary handle 27 being aligned, whereby, primary nut member 24 and secondary nut member 25 are oriented in a closed configuration having opening 29.

Primary hydraulic linear actuator 8 and secondary hydraulic linear actuator 11 each can have at least one handle 20 (FIG. 1) adapted for a user to grasp. At least one handle 20 facilitates transport of plate heat exchanger compression apparatus 1.

In addition, at least one hydraulic linear actuator can be connected to barrier element 30 (FIG. 1) acting as a barrier between threaded rod 19 and hydraulic lines 14. Barrier element 30 prevents hydraulic lines 14 from becoming damaged during the plate heat exchanger opening and closing process. Barrier element 30 is located between opening 15 and opening 16. It is within the scope of this invention for barrier element 30 to be removably mounted to at least one contact structure.

Another embodiment of the novel plate heat exchanger compression apparatus 1 is that primary hydraulic linear actuator 8 and secondary hydraulic linear actuator 11 are removably mounted to primary contact structure 2 and secondary contact structure 3. Primary hydraulic linear actuator 8 and secondary hydraulic linear actuator 11 are interchangeable with a plurality of hydraulic linear actuators (not shown) having a plurality of differing lengths. The interchangeable lengths of cylinders are attached to the contact structures with including, but not limited to, pins. It is within the scope of this invention for the interchangeable lengths of cylinders to have a length of at least 2 inches.

Plate heat exchanger compression apparatus 1 is further improved with the hydraulic linear actuators having a length great enough to facilitate an increased travel length along threaded rod 19 of including, but not limited to, approximately 16 inches. However, it is within the scope of this invention for the travel length of the hydraulic linear actuators to have a length of at least 2 inches.

Plate heat exchanger compression apparatus 1 has primary hydraulic linear actuator 8 and secondary linear actuator 11 that operate on a lower hydraulic pressure than the prior art hydraulic opening and closing fixtures including, but not limited to, approximately 3,000 psi.

In addition to the aforesaid embodiments of plate heat exchanger compression apparatus 1, slip-on lock nut having at least one handle 23 is configured to be grasped by a user and includes multiple additional improvements as well.

A primary improvement as shown in FIGS. 5-7 is of slip-on lock nut having a primary handle 26 and a secondary handle 27 configured to be grasped by a user. Plate heat exchanger compression apparatus 1 can be secured to threaded rod 19 of plate heat exchanger 21 more quickly with fastener 18 being a slip-on lock nut having at least one handle 23. Although more labor some and not a preferred embodiment, a threaded nut would also accommodate being secured to threaded rod 19 as shown in FIGS. 2, 3, and 4.

At least one handle has a length great enough for a user to have enough leverage to align primary handle 26 with secondary handle 27 to orient primary and secondary nut members in a closed configuration along threaded rod 19. At least one handle has a length of including, but not limited to, approximately six inches to fourteen inches, configured to be grasped by a user. However, it is within the scope of this invention for at least one handle to have a length of at least 2 inches, configured to be grasped by a user.

Another embodiment is that primary handle 26 is a color and secondary handle 27 is a different color. FIG. 5 shows novel slip-on lock nut having primary handle 26 and secondary handle 27 separated away from each other, orienting the primary and secondary nut members in an open configuration adapted for recess 28 to receive threaded rod 19 (not shown). When primary handle 26 and secondary handle 27 are aligned with each other, the primary and secondary nut are oriented in a closed configuration (FIG. 6). This closed configuration forms a jam nut having opening 29 (FIG. 6), whereby, threaded rod 19 is located through opening 29. In another embodiment, primary handle 26 and secondary handle 27 are both the same color. It is within the scope of this invention that the alignment of primary handle 26 and secondary handle 27 can be more easily distinguishable from primary nut member 24 and secondary nut member 25 if the primary and secondary colors include, but are not limited to, fluorescent colors.

Another embodiment as shown in FIGS. 2, 3, and 7 is a method of hydraulically opening and closing plate heat exchanger 21 with plate heat exchanger compression apparatus 1. A user (not shown) removes at least one fastener 18 from threaded rod 19 of plate heat exchanger 21. A user obtains at least one plate heat exchanger compression apparatus 1 having primary contact structure 2 having opening 15 located opposite secondary contact structure 3 having opening 16. The user positions primary surface 4 of primary contact structure 2 in contact with a surface of plate 17. Opening 15 and opening 16 receive threaded rod 19 through opening 15 and opening 16. Plate heat exchanger compression apparatus 1 is secured to threaded rod 19 with at least one fastener 18. At least one fastener 18 is in contact with primary surface 6 of secondary contact structure 3.

As best shown in FIG. 4, it is a preferred embodiment for a user to remove fasteners 18 from each of the four threaded rods 19 located at each outer corner of plate heat exchanger 21. It is also within the scope of this invention for fasteners 18 to not be removed from each of the four threaded rods 29 for the plate heat exchanger to be opened, but to be located further along the threaded rods. A plurality of plate heat exchanger compression apparatuses 1 are mounted to each of the four threaded rods 19 located at each corner of plate heat exchanger 21. The plurality of plate heat exchanger compression apparatuses 1 are each secured to the four threaded rods 19 located at each corner of plate heat exchanger 21 with fastener 18.

FIG. 3 illustrates the remaining adjacent threaded rods 22 receiving fasteners 18 to secure the plates of plate heat exchanger 21. As plate heat exchanger 21 is compressed, fastener 18 is moved to continue to secure plate heat exchanger compression apparatus 1 to threaded rod 19. Plate heat exchanger compression apparatus 1 is adapted to hydraulically compress plate heat exchanger 21 to allow clearance between plate 17 and fasteners 18 located on adjacent threaded rods 22. At least one fastener 18 is removed from at least one adjacent threaded rod 22. When all of fasteners 18 are removed from adjacent threaded rods 22, fasteners 18 can be removed from threaded rods 19 to allow plate heat exchanger compression apparatus 1 to decompress, thereby, opening plate heat exchanger 21. It is also within the scope of this invention for the plate heat exchanger compression apparatus 1 to be adapted to hydraulically compress plate heat exchanger 21, whereby at least one fastener 18 is tightened on an adjacent threaded rod. At least one fastener 18 secures a portion of the plate in a closed position.

These and other important objects, advantages, and features of the invention will become clear as this description proceeds.

An important object of this invention is to provide plate heat exchanger compression apparatus 1 to more easily compress the plates of plate heat exchanger 21 to allow clearance between plate 17 and fasteners 18 located on adjacent threaded rods 22. This clearance alleviates pressure on the threaded nuts, allowing the threaded nuts to spin more easily.

Another important object is to provide a slip-on lock nut having at least one handle 23 to secure plate heat exchanger compression device 1 to threaded rod 19 and to secure the plates of plate heat exchanger 21 to adjacent threaded rods 22, eliminating the need for time extensive threaded nut travel time along a threaded rod and eliminating the need for additional tools or additional maintenance personnel.

Additional objects include, but are not limited to, the provision of plate heat exchanger compression apparatus 1 having the following: an improved method of compressing the plurality of plates of a plate heat exchanger resulting in an increased travel length along the threaded rod of approximately 16 inches and a lower psi of approximately 3,000 psi; an improved slip-on lock nut having at least one handle having a length of at least 2 inches; an improved slip-on lock nut having a primary handle being a color and a secondary handle being a different color; and, an improved primary and secondary hydraulic linear actuator being interchangeable with a plurality of hydraulic linear actuators having a plurality of differing lengths.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

The invention claimed is:

1. A plate heat exchanger compression apparatus, comprising:
a first contact structure and a second contact structure;
said first contact structure and said second contact structure each having a first surface located opposite a second surface;
said first contact structure and said second contact structure each having an opening, whereby, said openings are configured to receive a threaded rod through said openings;
said first surface of said first contact structure in contact with a surface of a plate and said first surface of said second contact structure in contact with a fastener; and,
a first linear actuator and a second linear actuator each having a first end connected to said second surface of said first contact structure, said first linear actuator and said second linear actuator each having a second end connected to said second surface of said second contact structure.

2. The plate heat exchanger compression apparatus of claim 1, wherein said first linear actuator and said second linear actuator each being connected to a hydraulic source, said hydraulic source capable of transferring a fluid to or from said first linear actuator and said second linear actuator.

3. The plate heat exchanger compression apparatus of claim 1, wherein said first linear actuator and said second linear actuator are in hydraulic communication with each other, whereby, said fluid is equally supplied to said first linear actuator and said second linear actuator.

4. The plate heat exchanger compression apparatus of claim 1, wherein at least one linear actuator is connected to a barrier element, said barrier element is located between said openings.

5. The plate heat exchanger compression apparatus of claim 1, wherein said first linear actuator and said second linear actuator each have at least one handle adapted for a user to grasp.

6. The plate heat exchanger compression apparatus of claim 1, wherein said first linear actuator and said second linear actuator are removably mounted to said first contact structure and said second contact structure, whereby, said first linear actuator and said second linear actuator are interchangeable with a plurality of linear actuators having a plurality of differing lengths.

7. The plate heat exchanger compression apparatus of claim 1, wherein said fastener is a nut.

8. The plate heat exchanger compression apparatus of claim 1, wherein said fastener is a slip-on lock nut.

9. The plate heat exchanger compression apparatus of claim 8, wherein said slip-on lock nut has at least one handle configured to be grasped by a user.

10. The plate heat exchanger compression apparatus of claim 9, wherein said slip-on lock nut has a first handle and a second handle configured to be grasped by a user.

11. The plate heat exchanger compression apparatus of claim 10, wherein said first handle and said second handle being a color.

12. The plate heat exchanger compression apparatus of claim 9, wherein said at least one handle having a length of at least 2 inches.

13. A slip-on lock nut, comprising:
a first nut member rotatably connected to a second nut member, said first nut member and said second nut member each having at least one recess adapted to receive a rod;
at least one protrusion located on at least one nut member, said at least one protrusion radiating from said at least one nut member, whereby, said at least one protrusion is configured to be grasped by a user, said at least one protrusion having a length of at least 2 inches.

14. The slip-on lock nut of claim 13, wherein said first nut member having a first protrusion and said second nut member having a second protrusion configured to be grasped by a user.

15. The slip-on lock nut of claim 14, wherein said first protrusion and said second protrusion being a color.

16. The method of hydraulically opening or closing a plate heat exchanger with a plate heat exchanger compression apparatus, comprising the steps of:
removing at least one fastener from a threaded rod of said plate heat exchanger;
having at least one plate heat exchanger compression apparatus having a first linear actuator and a second linear actuator, said first linear actuator and said second linear actuator are located between a first contact structure and a second contact structure, whereby, said first contact structure and said second contact structure each have an opening;
positioning said first contact structure in contact with a surface of a plate, whereby, said openings of said first contact structure and said second contact structure receive said threaded rod through said openings;
securing said plate heat exchanger compression apparatus to said threaded rod with at least one fastener, whereby, said at least one fastener is in contact with said second contact structure; and,
hydraulically compressing said plate heat exchanger.

17. The method of claim 16, wherein said plate heat exchanger is hydraulically compressed to allow clearance between said plate and said at least one fastener of an adjacent threaded rod, whereby, said at least one fastener from said at least one adjacent threaded rod is removed from said threaded rod.

18. The method of claim 17, wherein said at least one fastener from said threaded rod is removed, allowing said plate heat exchanger compression apparatus to be removed.

19. The method of claim 18, wherein said plate heat exchanger is opened.

20. The method of claim 16, wherein said at least one fastener is tightened on an adjacent threaded rod, whereby, said at least one fastener securing a portion of said plate in a closed position.
